(19) United States
(12) Patent Application Publication
(10) Pub. No.: US 2004/0206555 A1
(43) Pub. Date: Oct. 21, 2004

(54) Stair chair

(76) Inventor: Mark S. Schneider, Pittsburgh, PA (US)

Correspondence Address: LELAND P. SCHERMER, LELAND SCHERMER & ASSOCIATES, 7TH FLOOR, 11 STANWIX STREET, PITTSBURGH, PA, 15222, US

(21) Appl. No.: 10/228,309

(22) Filed: Aug. 27, 2002

(51) Int. Cl. B62D 55/00

(52) U.S. Cl. 180/9.32

(57) ABSTRACT

An improved stair chair stretcher assembly for use in paramedic and other similar applications. Translational supports are attached to the stair chair stretcher assembly to allow medical transport personnel to move a patient up and down steps without having to hand carry the patient. The translational supports contact the edge of steps and permit the stretcher assembly to be securely moved along the steps. Also disclosed and claimed is a lifting means which allows for movement of a patient up and down along various points of the stair chair assembly, to improve ease of handling heavier patients.

### BACKGROUND OF THE INVENTION

1. Field of the Invention

The present invention relates to an improved stair chair utilized in transporting persons in need of medical assistance. More specifically, the present invention is a variant of an ambulance stretcher than can be used to mount steps where, for example, first aid workers must transport a patient up or down steps in order to place them in an emergency vehicle for transportation to a hospital or other care facility.

2. Description of the Prior Art

There are a number of versions of ambulance stretchers that have been used over the years. One such stretcher is manufactured by Ferno and is disclosed in the product brochures submitted with my information Disclosure Statement. One drawback of the Ferno ambulance stretcher is that it is not very easy to take a patient up and down the steps, even though the ambulance stretcher is specifically designed to act as a “chair” for patient movement (see page 3 of the Ferno product brochure).

One of the shortcomings of the Ferno ambulance stretcher is that the patient in the chair position of the stretcher must be lifted and carried up and down steps. The paramedics or other personnel who are carrying a patient in this manner risk injury to the patient, and themselves, due to the cumbersome nature of the stretcher in that it must be lifted and carried with a patient on it, where the patient is generally in a vertical position. As a result, there is a need in the art to improve the way in which an injured patient sitting in a chair-like stretcher position can be carried up and down steps.

Other patents show a variety of means for attempting to make a carrying structure be more mobile, with collapsible wheels or the like, applied in several different ways. For example, U.S. Pat. No. 4,192,541 to Ferneau discloses a cart having an extensible auxiliary wheels for easy transport of heavy objects. Also, U.S. Pat. No. 4,168,554 to Hindes discloses a cardiopulmonary resuscitation cot mattress wherein a cot is placed on a frame bearing wheels for easy horizontal transport of a medical patient. The '554 Hindes patent also discloses a hinged head and back section, which is rotatable downward to provide improved breathing opportunities for a patient in need of cardiopulmonary resuscitation. In addition, U.S. Pat. No. 4,251,178 to Bourgraf, et al. discloses a business machine cart with trunk loading attachments, wherein a basic cart comprises a wheel section, a handle section, and a platform or carriage on which the business machine or the like is secured. The wheel section of the cart is provided with a foot member by which the cart may be positioned in an essentially upright condition when the carriage is in the transport position. When it is desired to move the cart to another location, the user of the cart tilts the cart on its wheels to an inclined position and pulls or pushes the cart by means of a handlebar mounted at the uppermost end of the handle section.

The prior art generally discloses various means for attempting to make a weight-bearing structure capable of convenient horizontal movement. However, the prior art does not provide for a convenient way to take a patient on the stretcher in a sitting or chair-type position up and down steps. In fact, the Ferno brochure indicates that when stairs are encountered, the emergency medical personnel should lift and carry the patient in a generally horizontal position, even though the patient is sitting in the chair-type position.

Thus, it would be desirable to have a convenient way to take patients up and down steps on some form of ambulance stretcher. Therefore, it is an object of the present invention to provide a convenient means for transporting a patient sitting in a chair-type position up and down steps. It is still a further object of the present invention to provide an embodiment that employs a battery powered lift means for particularly heavy patients or for emergency personnel not capable of carrying heavy patients or for emergency personnel not capable of carrying heavy loads, to help place the patient at various points along the vertical portion of the stretcher. These and other objects will be more fully explained in the detailed description provided hereafter, as well as the claims provided herein.

### SUMMARY OF THE INVENTION

The apparatus and method of the present invention permits the use of an ambulance stretcher in a chair-like position for those patients for whom that is necessary, while at the same time allowing such patients to be transported up and down stairs of a staircase without the need for the emergency or other medical staff to carry the patient by hand. One structural addition to a prior art ambulance stretcher that permits the use of the present invention is a pair of opposed translational supports that attach to the bottom rear portion of an ambulance stretcher when in an upright or chair-like position. The “crawler assembly” utilized herein can be seen in U.S. Pat. No. 5,253,881, the entire disclosure of which is incorporated by reference herein. The '881 patent discloses the use of a crawler assembly on a dolly. In the crawler assembly as adapted to an ambulance stretcher, the translational supports are in the shape of an elongated oval and include a heavy-duty rubber belt around its periphery with a plurality of roller bearing members beneath the rubber belt. Collectively, these structures permit the weight of the stretcher with a patient on it to be borne along the rubber belt, which belt permits translational movement of the stretcher and patient due to its rotational capabilities provided for by the roller bearing members located on the underside of the rubber belt.

When a patient is sitting on the stretcher in a chair-like position, and medical personnel approach a staircase, the stretcher can be tilted back to approximately thirty to forty-five degrees from the vertical, which allows for the translational supports to contact the edge of a step. I have named by invention the “Pittsburgh Chair” due to the hilly nature of my hometown and the resulting need to carry patients up and down steps in tight quarters. If a patient needs to be taken down the steps, the medical personnel can secure the stretcher from the top (and, for added safety, from the bottom) and allow the stretcher with patient combination to translate down the step through the contact of the translational members. Similarly, if a patient needed to be taken up a set of steps, the translational member can be made to contact the front edge of a step and the emergency or other medical personnel can pull the stretcher with the patient on it up the steps by having the translational member contact the front edge of the step that is being mounted and pulling the stretcher up that front edge along the translational member under the additional wheels originally on the stretcher make contact with the step below the one in questions. By repeating this procedure, a patient can be moved up and down steps in a manner that reduces risk of injury to the patient and risk of injury to the medical personnel who had heretofore been required to carry the patient and stretcher.

A second embodiment of the present invention can use a battery powered electric motor lifting means instead of or in addition to the translational members. In this second version, which is modeled after the Manhandler Supreme product shown in the literature submitted with the information Disclosure Statement, an electro-mechanical lifting means is attached to the stretcher to permit movement and placement of the patient along various points of the vertical portion of the stretcher, which in turn provides for better control of the weight and general ease of transport.

### BRIEF DESCRIPTION OF THE DRAWINGS

FIG. 1 is a side view showing the stretcher of the present invention with the translational members attached to the bottom rear portion of the stretcher in the chair-like position.

FIG. 2 shows the translational member of the present invention in use on a set of steps.

FIG. 3a shows an exploded view of the translational member.

FIG. 3b shows a side view of the relationship between the heavy-duty rubber belt, the elongated oval-shaped body of the translational member and a plurality of roller bearing members.

FIG. 4a shows a back view of the embodiment using a battery powered electric motor lift means on a stretcher.

FIG. 4b shows a stretcher of the present invention having both a pair of translational members and a battery powered electric motor lift means.

### DETAILED DESCRIPTION OF THE PREFERRED EMBODIMENT

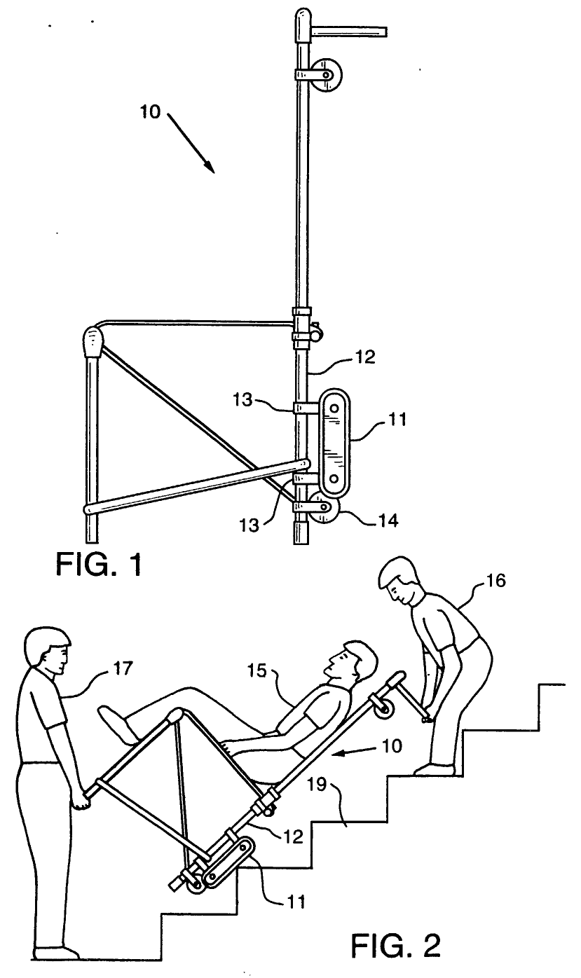

The present invention will best be seen and understood by way of a preferred embodiment, particularly as shown in FIGS. 1, 2, 3a, 3b, 4a and 4b.

Referring to FIG. 1, a side view is shown of the present invention. Translational member 11 is attached to the bottom rear portion of ambulance stretcher 10. Translational member 11 is secured to a post 12 of ambulance stretcher 10 that is vertical when ambulance stretcher 10 is in the upright or chair-like position as shown in FIG. 1. Translational member 11 is secured to post 12 by means of a pair of brackets 13. It is important that translational member 11 be tightly secured by brackets 13, and that translational member 11 be secured in the lower rear portion of ambulance stretcher 10 when in the vertical or chair-like position. This is necessary so that a patient can be carried up and down steps on translational member 11, which is accomplished by use of basic physics principles to rotate the weight about translational member 11. Wheel 14 must not be in contact with translational member 11, but it must be near the bottom of post 12 to provide for horizontal movement of ambulance stretcher 10 when a patient is not being carried up or down steps.

Referring to FIG. 2, the patient 15 is carried on ambulance stretcher 10 by emergency or other medical personnel 16 and 17. As can be seen, ambulance stretcher 10 is balanced on the edge of a step by rotating it such that translational member 11 supports the rotational and translational movement of ambulance stretcher 10. Post 12 can be seen as having been rotated approximately thirty to forty-five degrees from the vertical. This general arrangement can be used for traveling up or down steps. As is apparent, personnel 16 and 17 would have difference weight-bearing responsibilities depending upon whether the patient is being taken up or down steps.

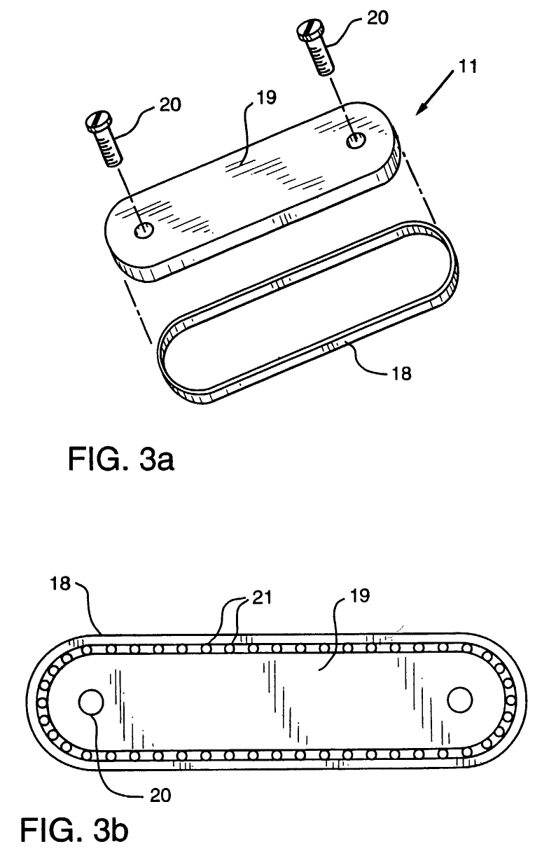

Referring to FIG. 3a, the exploded view of a translational member 11 is shown. Heavy-duty rubber belt 18 is shown as having been removed from elongated oval body 19 of translational member 11. Bolts 20 are shown as having been removed from elongated oval body 19. Bolts 20 secure the various parts of translational member 11 together, as described in U.S. Pat. No. 5,253,881, which has been incorporated by reference herein.

Referring to FIG. 3b, heavy-duty rubber belt 18 is shown in a perspective view as it fits on the periphery of body 19. Belt 18 is rotatable about body 19 by means of a plurality of roller bearing members 21.

Translational member 11 is not, in itself, my invention as this item is a purchased item. However, the adaptation of translational member 11 to ambulance stretcher 10 is one embodiment of my invention, an invention that is not obvious to a person skilled in this art.

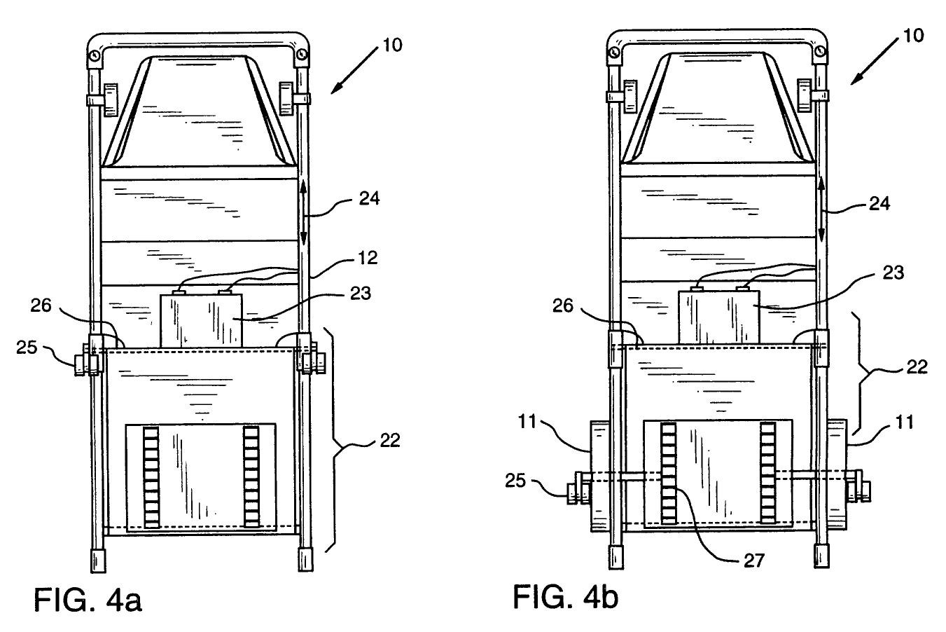

FIG. 4a shows a battery powered lifting means 22 that includes a battery 23 powered electric motor for lifting the patient or lowering the patient along the vertical portion 24 of posts 12 of a stretcher 10. A pair of lifting feet 25 is shown, which secures in place seat 26 that allows the patient to be lifted or lowered along vertical portion 24.

FIG. 4b shows a pair of oppositely disposed translational members 11 on stretcher 10 along with lifting means 22 comprising a battery 23 powered electric motor and a pair of lifting feet 25, which are attached to a continuous drive chain. In this embodiment of my invention, the patient can be lifted and lowered along the vertical portion 24 of stretcher 10, and when steps are encountered, the translational members 11 can be used to lift and lower a patient along the steps.

My present preferred embodiment of the invention has been described herein. It is to be distinctly understood that the invention is not limited to the specific embodiment shown herein, but may be configured in other ways and be within the scope of the following claims.

What is claimed is:

1. An improved stair chair stretcher comprising:
(a) a plurality of posts that are vertical when the stretcher is in the chair-like position; and
(b) a plurality of translational members attached to said posts generally near what is the bottom of said posts when said ambulance stretcher is in a chair-like position.

2. The invention of claim 1, wherein said translational member comprises a heavy-duty rubber belt rotatably mounted on an oval shaped body.

3. The invention of claim 1 further comprising a lifting means secured to said posts, which permits a seat to be moved up or down along said posts.

4. The invention of claim 3 wherein said lifting means is battery powered.

5. An improved stair chair stretcher comprising:
(a) a plurality of posts that are vertical when the stretcher is in the chair-like position; and
(b) a lifting means secured to said posts, which permit a seat to be moved up or down along said posts.

6. The invention of claim 5, wherein said lifting means is battery powered.

7. A method of transporting a patient on an ambulance stretcher comprising the steps of:
(a) providing a stair chair stretcher with a plurality of translational members on a plurality of posts of said stretcher, which posts are oriented vertically when said stretcher is in a chair-like position.
(b) Placing a patient on said stretcher when the stretcher is in a chair-like position,
(c) Placing said translational member in contact with the front edge of a step,
(d) Rotating the upper portion of said stretcher between about thirty-forty-five degrees from the vertical; and
(e) Pulling the combined stretcher and patient up a step by having said translational member rotate while in contact with the front edge of said step.

8. A method of transporting a patient on an ambulance stretcher comprising the steps of:
(a) providing a stair chair stretcher with a plurality of translational members on a plurality of posts of said stretcher, which posts are oriented vertically when said stretcher is in a chair-like position,
(b) placing a patient on said stretcher when the stretcher is in a chair-like position,
(c) rotating the upper portion of said stretcher between about thirty to forty-five degrees from the vertical, and
(d) placing said translational member in contact with the front edge of a step,
(e) lowering the combined stretcher and patient down a step by having said translational member rotate while in contact with the front edge of said step.
